(19) United States
(12) Patent Application Publication
(10) Pub. No.: US 2006/0035603 A1
(43) Pub. Date: Feb. 16, 2006

(54) Reconfigureable system architecture

(76) Inventor: Adnan Al-Adnani, London (GB)

Correspondence Address: RATNERPRESTIA, P O BOX 980, VALLEY FORGE, PA, 19482-0980, US

(21) Appl. No.: 10/531,134

(22) PCT Filed: Nov. 20, 2003
(86) PCT No.: PCT/GB03/05054

§ 371 Date: Apr. 13, 2005

(30) Foreign Application Priority Data
Nov. 21, 2002 (GB) 0227260.7

(51) Int. Cl. H04B 1/38

(52) U.S. Cl. 455/90.2

(57) ABSTRACT

Reconfigurable signal processing architecture includes a reconfigurable data processing module in which data is input to the module in a packet frame structure including configuration frames and processing frames. Each frame includes a header having at least one mode selection bit indicating whether the frame contains reconfiguration data or processing data. The module is operable in a reconfiguration mode or a processing mode according to the content of the frame header.

The present invention relates to reconfigurable system architecture. It has been designed for digital radio transmitters and receivers in particular but has many other potential applications.

### BACKGROUND

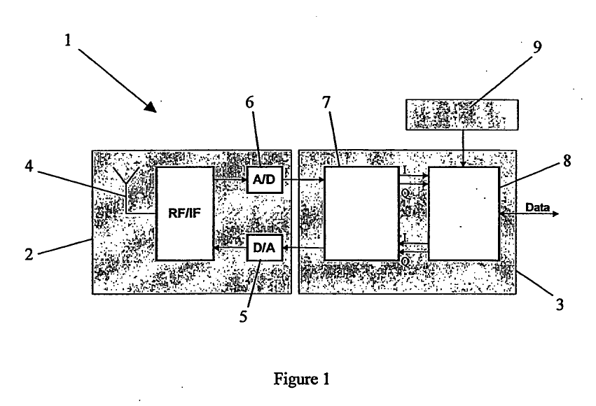

FIG. 1 is a diagram of a generic digital radio transceiver having an analogue processing Section 2 and a digital processing Section 3. A radio frequency (RF) signal is radiated/intercepted by an antenna 4 and subsequently filtered, amplified, and upconverted/downconverted to an intermediate frequency (IF) in the analogue processing Section 2. The signal is converted to analogue/digital signals using the D/A and A/D blocks (5, 6). The digital front-end block 7 performs Digital Up/Downconversion and sample rate conversion of the digital signals. The Baseband DSP block 8 performs all the data processing necessary to prepare the signal for transmission/reception. All of the foregoing is done in real time.

The digital front end 7 is implemented on hardware due to the computational complexity and has a fixed structure. Reconfigurable hardware for example FPGAs (field programmable gate arrays) can be used to implement the digital front end 7 to provide more flexibility & reconfiguration.

The DSP baseband algorithms are stored in non-volatile memory and are loaded into the DSP from program memory 9 at run-time. To modify the DSP operation new programs can be loaded into memory 9 offline with a specific reconfiguration protocol.

The use of reconfigurable architectures is gaining an important role in the system-on-a-chip design platforms. Applying reconfigurable architecture to implement not only the dataflow intensive computations but also the control oriented computation (Layer 1, Layer 2 or Layer 3 software for network protocol processing) or data stream based computation (e.g. data routing, shuffling and interleaving) is a very promising approach.

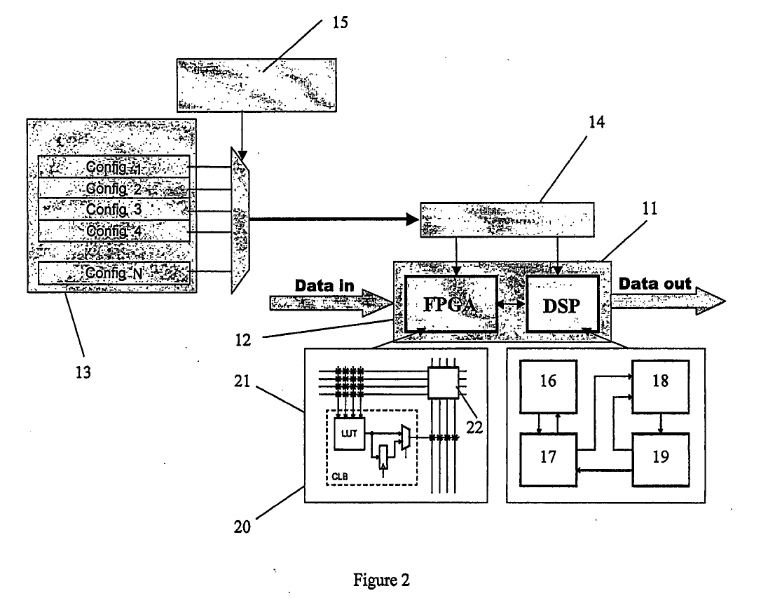

FIG. 2 shows the basic recongurable architecture model where configurations for DSPs and FPGAs, one of each which is indicated by 11, 12, are previously downloaded to the configuration memory 13. The basic architecture model of DSP typically includes data memory 16, functional unit 17, controller 18 and instruction memory 19. An FPGA typically includes a configurable logic block (CLB) 20 including look up table 21 and switch matrix including switch box 22. A configuration controller 14 loads the selected configuration to DSP program memory 16 or FPGA distributed SRAM that realizes the logic functions and routing between logic blocks. The choice of configuration is controlled by configuration select logic 15.

The reconfigurable software still takes up a large portion of the resultant cycle/energy even though optimizations can reduce the cost significantly. Part of the reason is that the configuration is done via a microprocessor. One potential optimization is to have a dedicated configuration code generator or DMA to take care of the configuration data movements.

Reconfigurable systems are usually formed with a combination of reconfigurable logic and a general-purpose microprocessor. The processor performs the operations that cannot be done efficiently in the reconfigurable logic, such as data dependent control and possibly memory accesses, while the computational cores are mapped to the reconfigurable hardware. This reconfigurable logic can be supported either by commercial FPGAs or by custom configurable hardware.

An example of a reconfigurable processor is the Chameleon Systems Reconfigurable Communication Processor (RCP). The RCP provides a platform-based approach that incorporates three core architectural technologies: a complete 32-bit embedded processor subsystem, a high-performance 32-bit reconfigurable processing fabric, and eConfigurable Technology. The RCP architecture disclosed in U.S. Pat. No. 6,288,566.

In this architecture, a configuration bit stream is stored in the main memory. It is loaded onto the fabric at runtime by DMA. Each reconfigurable fabric slice has two planes for bit streams. An active plane executes the working bit stream and a back plane contains the next configuration bit stream. Switching from the back plane to the active one takes one cycle. Therefore, the back plane can be effectively used as cache for loading configuration.

The RCP is targeted for 3G wireless basestations and not suitable for low power devices. Traditional approaches implement each of the four chip-rate processing algorithms as separate hardware modules in ASICs or FPGAs.

The present invention aims to achieve a number of desirable characteristics in a reconfigurable architecture.

The desirable characteristics are:
Run-time reconfigurabilty of the digital processing section
Method of reconfiguration control using data packets
Data processing and reconfiguration synchronisation
Energy efficient implementation for low power devices

A power efficient design relies on the integration of algorithm developments and architecture design to exploit the full potential of communications theoretical results and advanced technology.

It would therefore be advantageous to perform algorithm level selections and modifications based on efficient implementation criteria, which can lead to vastly reduced processing requirements without system performance degradation. Architectures would be needed to match the computational requirements of the signal processing algorithm (filtering, coding, equalization, etc), which can lead to vastly reduced implementation cost and energy consumption and at the same time providing sufficient flexibility.

The patent invention provides reconfigurable signal processing architecture including a reconfigurable data processing module in which data is input to the module in a packet frame structure including configuration frames and processing frames, each frame including a header having at least one mode selection bit indicating whether the frame contains reconfiguration data or processing data, and in which the module is operable in a reconfiguration mode or a processing mode according to the content of the frame header and mode selection bits are separated from data in each frame and used to control mode selection logic in the module determining how incoming data is handled.

Thus, in contrast to prior art such as that shown in FIG. 2 in which configuration data is input to a reconfigurable module separately from data to be processed, in the present invention the reconfigurable module receives configuration data in the same packet frame structure as the real time processing data.

It will be appreciated that this single module structure can be extended to include several similar modules.

The preferred solution presented is thus a modular implementation approach, which preserves the structures of signal processing block to establish connections between algorithm, architecture and physical level for high predictability and quick feedback, and increases productivity through reusing building blocks.

A direct mapped approach and a predetermined module library are centric to this approach, where each coarse gain function of the algorithm implementing the signal processing block is mapped to a highly optimized dedicated hardware. Having done this it is possible to estimate changes in performance, power and area resulting from any reconfiguration using computer modeling.

An embodiment of the invention will now be described by way of example only and with reference to the accompanying drawings in which:

FIG. 1 is a schematic block diagram of a generic digital transceiver;

FIG. 2 is a schematic block diagram of a basic reconfigurable architecture model;

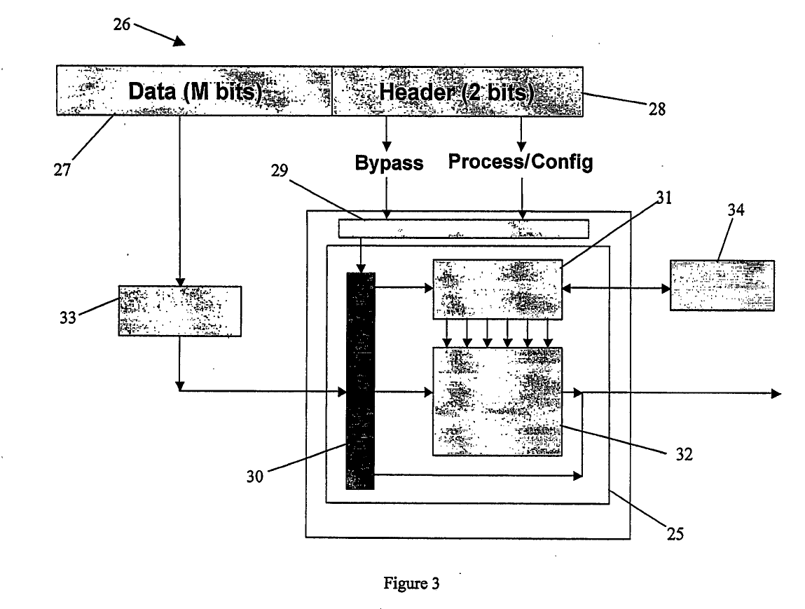

FIG. 3 is a schematic block diagram of a reconfigurable digital processing architecture according to the invention;

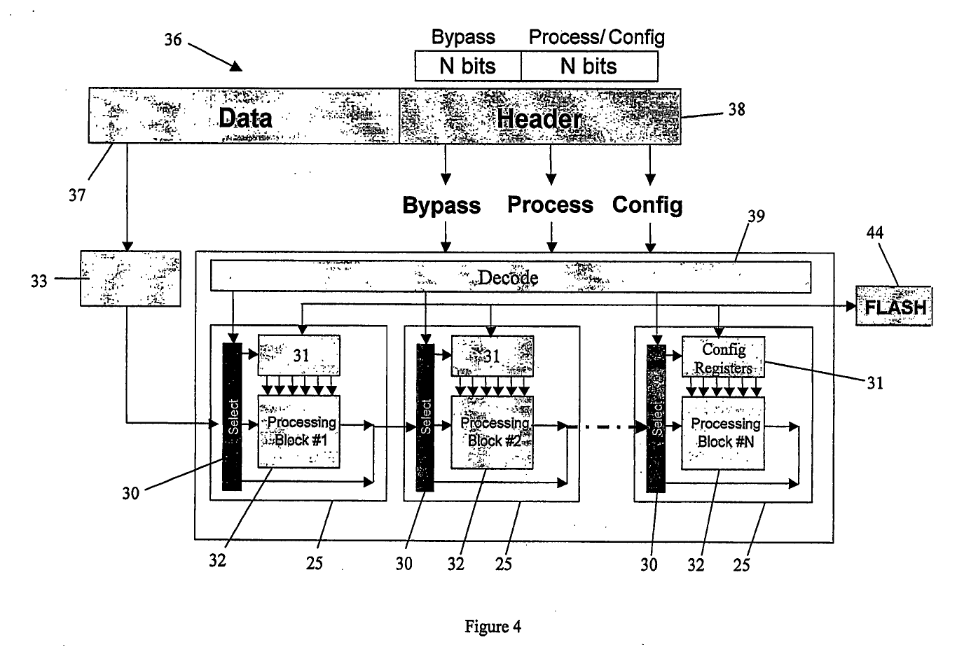

FIG. 4 shows the architecture of FIG. 3 extended to a plurality of reconfigurable processing modules; and

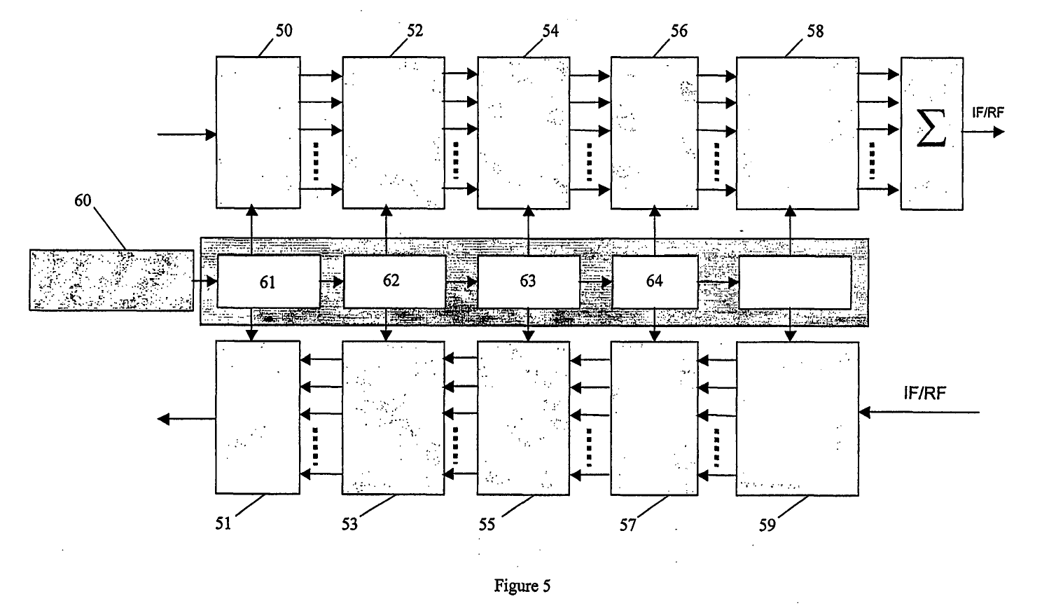

FIG. 5 shows an example of the architecture of FIG. 4 used for the specific application of adaptive modulation.

A novel modular reconfigurable architecture & method of reconfiguration is now described. The purpose is to allow run-time reconfiguration of the real-time digital processing section of the digital radio. The proposed architecture can be realized in software or hardware depending on the computational complexity, power requirements of the system.

FIG. 3 shows the basic structure of the solution. A reconfigurable processing module 25 is driven by a packet frame structure generally indicated at 26 that provides the data to be processed by the module and reconfiguration data in a data section 27. The header 28 contains the control bits that determine the mode of operation of the processing module 25. The module receives mode selection data from decoded block 29 and includes mode select 30, configurable registers 31 and processing block 32. Data is supplied to mode select block 30 via buffer 33.

The module can operate in 3 modes.
1) Bypass mode effectively switching off the module 25, that is the module passes the data without modification
2) Process mode where data provided by the packet is processed by the processing block 32.
3) Reconfiguration mode where the data in the frame contains reconfiguration parameters for the config. registers 31 to modify the operation of the processing block 32. The connection between the config registers and the processing block is wide enough to ensure real-time reconfiguration.

The configuration parameters are stored in Flash memory 34 which can be also loaded as the default parameters for future operation.

The decode block 29 decodes the header to determine the mode of operation to drive the select block 30. As a result, a separate control signal from a separate control channel is not necessary. The buffer block 33 stores the data until the header 28 is decoded and processing block 32 is ready for the data.

The common frame structure for delivering user data and configuration data simplifies the operation by avoiding the synchronisation problem required when data and control information are sent separately to the system as in the example of FIG. 2. The size of the data field is variable and is determined by the digital radio system or other application implemented.

Differences in data rates between frame delivery, and rate of operation of the configurable register 31 and processor 32 are accommodated by the buffer 33 which acts as rate adaptor.

For example, it may be necessary to buffer several frames for a complete reconfiguration of configuration register 31. Similarly buffer 33 assists in rate adaptation if the frame rate is different from the processor rate.

With one module, only two mode selection bits are needed. For example, the first of the two bits may indicate by pass mode, the second configuration mode and two nulls processing mode, as indicated in the table below:

| | | |
|---|---|---|
| 1 | X | Bypass |
| 0 | 0 | Process |
| 0 | 1 | Reconfigure |

Depending on the mode the select block 30 passes data to the configuration registers 31, processing block 32 or straight to the output.

The effective mode switching between recinfiguration and processing takes no time because the processing and reconfiguration data are in the same frame structure.

A further embodiment of the architecture is shown in FIG. 4 in which like parts in FIG. 3 have like numerals. The structure contains N number of processing blocks 32 that can implement a chain of modules 25 that can be reconfigured as required to implement a flexible digital radio. The header 38 is extended to 2N bits to provide separate control for each processing block 25. An extended decoder 39 serves all of the modules as does an extended flash memory 44.

The reconfiguration data contained in the frame can be used for one of the blocks or all. In this case the length of the data field 37 can be N*M bits.

The modules need not necessarily be in series. FIG. 3 could be extended to include parallel modules. In that case the header and the decoder would need to handle an address field for module identification.

The entire digital radio processing section of a radio transceiver can be implemented using this architecture. A digital IF section can be implemented on reconfigurable hardware using this architecture where filter parameters can be easily updated at run-time.

For the baseband section FIG. 5 is an example of a reconfigurable modulation architecture where a number of modulation schemes from single to multicarrier modulation schemes can be implemented using FPGAs, DSPs or a combination. The blocks can be combined and controlled using the multimode structure of the invention.

FIG. 5 shows serial parallel convertor 50 receiving data for transmission on the transmitter side mirrored by parallel/serial converter 51 on the receiver side, constellation mapping 52, de-mapping 53, spreading controller 54, and corresponding Rake combiner 55, pulse shapers 56, 57 and multi-carrier modulation and de-modulation 58, 59. In a modular system of this kind, configuration controller 60 would control parameters for the respective pairs of the modules such as framing (block 61) array mapping (block 62), spreading codes (block 63), filter coefficients (block 64) and sub-carrier frequencies (block 65).

The packet based data structure also has an advantage for implementing modulation schemes that are adaptive according to the quality of the communication channel. A configuration data frame can be formed to reconfigure the transmitter to a more suitable modulation scheme as soon as the received packet is processed by the receiver, thus maintaining a good quality connection. This is a major requirement for all future generation communication systems.

The structure in FIG. 5 can be implemented using the arrangement shown in FIG. 3 where each block can be mapped to a reconfigurable processing module.

Other baseband blocks can also be incorporated such as channel coding and equalisation to implement a complete system that can be configured to any communication standard.

1. Reconfigurable signal processing architecture comprising a reconfigurable data processing module in which data is input to the module in a packet frame structure including configuration frames and processing frames, each frame including a header having at least one mode selection bit indicating whether the frame contains reconfiguration data or processing data, and wherein the module is operable in a reconfiguration mode or a processing mode responsive to of the frame header and the mode selection bits are separated from the data in each frame and are used to control mode selection logic in the module for determining how incoming data is handled.

2. Architecture as claimed in claim 1 comprising a plurality of reconfigurable data processing modules each of which receives data in said packet frame structure and each of which is operable in a reconfiguration mode or a processing mode according to the frame header.

3. Architecture as claimed in claim 2 in which the frame header contains at least one mode selection bit for each of the modules.

4. Architecture as claimed in claim 3 in which the mode selection bits are decoded by a single decoder serving a plurality of modules.

5. Architecture as claimed in claim 4 in which the decoded mode selection data is supplied to the modules in parallel.

6. Architecture as claimed in claim 2 in which the modules are connected to each other in series.

7. Architecture as claimed in claim 1 in which at least one of the modules is additionally operable in a bypass mode in which incoming data is not acted on by the module and in which the header additionally indicates whether or not the module is to act on the data.

8. A radio signal processing apparatus in which signals are processed digitally, in which at least some components of the digital processing section of the apparatus are configurable and incorporate architecture as claimed in claim 1.

9. Architecture as claimed in claim 1 in which default up configuration data is supplied to the at least one module from memory outside the at least one module.

10. A radio signal processing apparatus according to claim 8 wherein the apparatus is selected from a group consisting of a receiver, a transmitter or a transceiver.

11. Architecture as claimed in claim 1 including a plurality of said reconfigurable data processing modules wherein each of the modules is configured to be operated in a bypass mode in which incoming data is not acted on by the module and in which the frame header additionally indicates whether or not the module is to act on the data.
